(19) United States
(12) Patent Application Publication
(10) Pub. No.: US 2010/0097499 A1
(43) Pub. Date: Apr. 22, 2010

(54) IMAGE PICKUP APPARATUS AND METHOD OF USING THE SAME

(75) Inventor: Mineki Taoka, Yokohama (JP)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/575,568

(22) Filed: Oct. 8, 2009

(30) Foreign Application Priority Data
Oct. 20, 2008 (JP) 2008-269771

(51) Int. Cl. H04N 5/262; H04N 5/217; H04N 5/232

(52) U.S. Cl. 348/240.99; 348/241; 348/345; 348/E05.078; 348/E05.055; 348/E05.045

(57) ABSTRACT

An image pickup apparatus capable of capturing a clear image by preventing a small depth of field, and a method of using the same. The image pickup apparatus and method employ a focusing information calculation unit calculating focusing information of a captured image from an image signal read from an image pickup device, a low pass filter removing high-frequency components from the image signal, and a filter control unit controlling the low pass filter to filter a region of the captured image. The filter control unit adjusts low pass filter characteristics differently based on the focusing information obtained from the image signal. Accordingly, the image pickup apparatus and method are capable of preventing a small depth of field and capturing a clear image.

### CROSS-REFERENCE TO RELATED PATENT APPLICATION

This application claims the benefit of Japanese Patent Application No. 2008-269771, filed on Oct. 20, 2008, in the Japanese Intellectual Property Office, the entire contents of which are incorporated herein by reference.

### BACKGROUND OF THE INVENTION

1. Field of the Invention

The present invention relates to an image pickup apparatus and method of using the same. More particularly, the present invention relates to an image pickup apparatus capable of preventing a small depth of field and capturing a clear image, and a method of using the same.

2. Description of the Related Art

Currently, in image pickup apparatuses such as digital cameras, image pickup devices are getting larger in order to capture higher quality images. For example, in a digital camera of a single-lens reflex type, an image pickup device of a 35 mm full size (24 mm×36 mm) allows for capturing of high-quality images. Also, a digital camera including a large-sized image pickup device can employ a fast lens for capturing bright images, and thus is appropriate for use in places having insufficient light. Also, with respect to an image pickup apparatus such as a digital camera, Japanese Patent Publication No. 2007-181193, for example, discloses a technology for restoring image data in an out-of-focus region by using a convolution filter.

However, in order to obtain the same magnification ratio of an image captured by an image pickup apparatus including a small-sized image pickup device, an image pickup apparatus including a large-sized image pickup device needs to have a long focal length. In other words, if an image pickup apparatus including a large-sized image pickup device has the same viewing angle as that of an image pickup apparatus including a small-sized image pickup device, the image pickup apparatus including the large-sized image pickup device has a focal length longer than that of the image pickup apparatus including the small-sized image pickup device. As such, an image pickup apparatus including a large-sized image pickup device may capture an image having a small depth of field.

Also, although a fast lens for capturing bright images may be employed in an image pickup apparatus including a large-sized image pickup device, if the fast lens is used, an f number is decreased while an iris is opened. Thus, the depth of field becomes small. In this case, although the depth of field may become large by narrowing the iris, the advantage of the fast lens at places having insufficient light is removed.

### SUMMARY OF THE INVENTION

The present invention provides a new and improved image pickup apparatus capable of capturing a clear image by preventing a small depth of field.

An embodiment of the present invention provides an image pickup apparatus including a focusing information calculation unit for calculating focusing information of a captured image from an image signal read from an image pickup device,a low pass filter for removing high-frequency components from the image signal; and a filter control unit for controlling the low pass filter to filter a region of the captured image. The filter control unit adjusts low pass filter characteristics differently based on the focusing information obtained from the image signal. As such, the contrast of a captured image is controlled based on focusing information, a small depth of field is avoided, and thus, a clear image may be captured.

The filter control unit may reduce high-frequency removal characteristics of the low pass filter in an out-of-focus region of the captured image compared to those in an in-focus region of the captured image, based on the focusing information. As such, the contrast of an image in an out-of-focus region is increased, a region having a high resolution sense is increased on the image, and thus, a large depth of field may be achieved.

The filter control unit may not perform high-frequency removal using the low pass filter on the image signal of an out-of-focus region of the captured image, based on the focusing information. As such, the contrast of an image in an out-of-focus region is increased, a region having a high resolution sense is increased on the image, and thus, a large depth of field may be achieved.

The image pickup apparatus may further include a processing unit for resizing or interpolating the image signal when the image signal is input, and the processing unit may resize or interpolate the image signal of an out-of-focus region of the captured image. As such, a clear image and a large depth of field may be achieved by performing only interpolation or resizing without removing high-frequency components through a low pass filter.

Another embodiment of the present invention provides an image pickup apparatus including a focusing information calculation unit for calculating focusing information of a captured image from an image signal read from an image pickup device, a low pass filter for removing high-frequency components from the image signal, a first processing unit for resizing or interpolating the image signal output from the low pass filter so as to output first image data, and a second processing unit for resizing or interpolating the image signal read from the image pickup device so as to output second image data. The image pickup apparatus further includes a weight determination unit for determining weights of the first image data and the second image data based on the focusing information; and an adder for linearly combining the first image data and the second image data according to the weights. The weight determination unit may increase the weight of the first image data and reduce the weight of the second image data in an in-focus region of the captured image, based on the focusing information. As such, since a ratio of first image data to second image data varies based on focusing information, a clear image and a large depth of field may be achieved by increasing the ratio of the second image data in an out-of-focus region.

### BRIEF DESCRIPTION OF THE DRAWINGS

The above and other features and advantages of the present invention will become more apparent by describing in detail exemplary embodiments thereof with reference to the attached drawings in which:

FIG. 1 is an example of a block diagram of an image pickup apparatus according to an embodiment of the present invention;

FIG. 2 is an example of a block diagram of a camera processing unit illustrated in FIG. 1, according to an embodiment of the present invention;

FIG. 3 is a block diagram of an example of a Bayer resizing unit illustrated in FIG. 1, according to an embodiment of the present invention;

FIGS. 4A and 4B are graphs showing examples of frequency band removal characteristics of horizontal and vertical low pass filters (LPFs) illustrated in FIG. 3, according to an embodiment of the present invention;

FIGS. 5 and 6 are graphs showing examples of amplitude characteristics of an LPF according to tap coefficients calculated by a tap coefficient calculation unit illustrated in FIG. 3, according to an embodiment of the present invention; and

FIG. 7 is a block diagram of an example the Bayer resizing unit illustrated in FIG. 1, according to another embodiment of the present invention.

### DETAILED DESCRIPTION OF THE EMBODIMENTS

Hereinafter, the present invention will be described in detail by explaining embodiments of the invention with reference to the attached drawings. Like reference numerals denote like elements in the drawings and thus repeated descriptions thereof may not be provided.

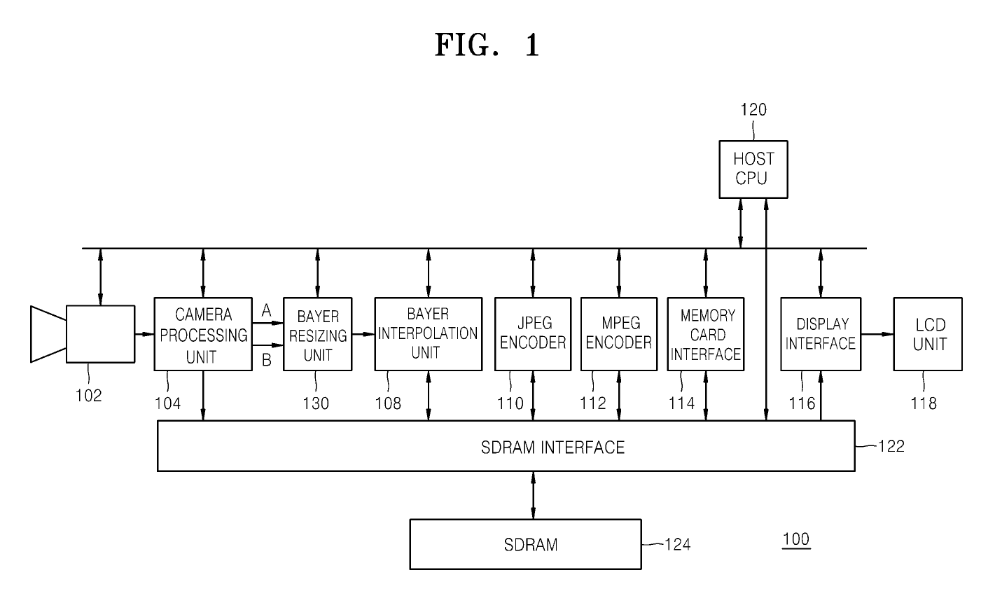

FIG. 1 is a block diagram of an image pickup apparatus 100 according to an embodiment of the present invention. The image pickup apparatus 100 includes a camera unit 102, a camera processing unit 104, a Bayer resizing unit 130, a Bayer interpolation unit 108, a Joint Photographic Experts Group (JPEG) encoder 110, a Moving Picture Experts Group (MPEG) encoder 112, a memory card interface 114, a display interface 116, a liquid crystal display (LCD) unit 118, a host central processing unit (CPU) 120, a synchronous dynamic random access memory (SDRAM) interface 122, and an SDRAM 124.

The camera unit 102 includes a lens optical system (not shown) and an image pickup device (not shown). In this embodiment, the lens optical system has an optical zoom function for varying a focal length by moving a group of lenses. Also, the image pickup device includes a sensor such as a charge coupled device (CCD) or a complementary metal oxide semiconductor (CMOS).

In the camera unit 102, the lens optical system forms an image of a subject on an image pickup surface of the image pickup device and the image pickup device obtains an image signal. The image signal obtained by the image pickup device is output in a Bayer pattern. The camera processing unit 104 performs various correction operations such as obtaining of focusing information, obtaining of auto-exposure (AE) information, compensation for lost data, and shading of an optical lens on the Bayer data. The focusing information may be obtained by, for example, determining high-frequency components in the image signal by using a high pass filter (HPF) included in the camera processing unit 104. Also, the focusing information may be obtained by using, for example, a phase difference sensor.

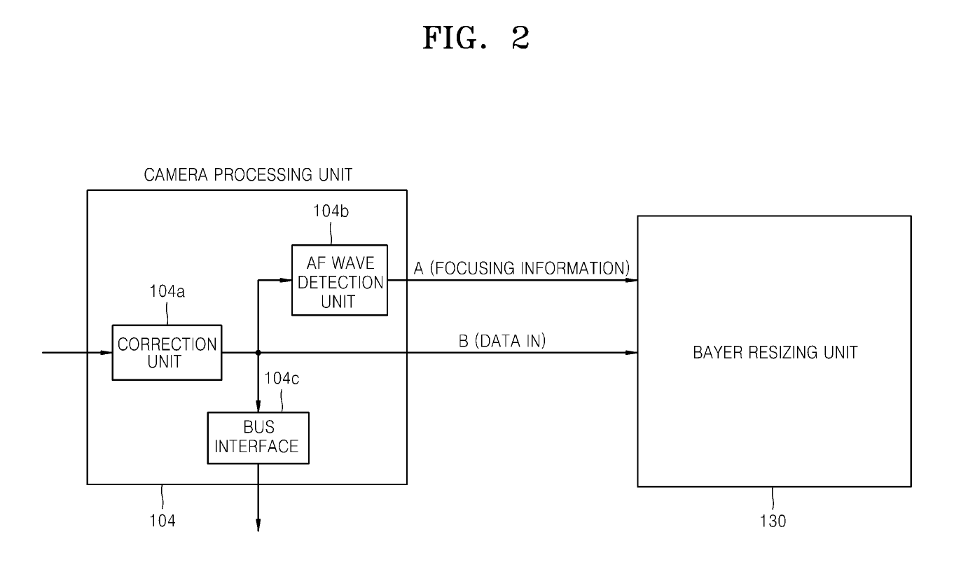

FIG. 2 is an example of a block diagram of the camera processing unit 104 illustrated in FIG. 1, according to an embodiment of the present invention. The camera processing unit 104 includes a correction unit 104a, an auto-focus (AF) wave detection unit 104b, and a bus interface 104c. The correction unit 104a performs various correction operations such as compensation for lost data on an input image signal of Bayer data. The AF wave detection unit 104b detects focusing information from the corrected image signal of Bayer data. Also, the bus interface 104c is connected to the SDRAM interface 122 illustrated in FIG. 1 and the corrected image signal of Bayer data is transmitted to the SDRAM interface 122 via the bus interface 104c.

Referring back to FIG. 1, if a captured image is a video image, image data processed by the camera processing unit 104 is transmitted in the form of Bayer data to the Bayer resizing unit 130 through a path B. The Bayer resizing unit 130 removes interference waves from the image data by using a low pass filter (LPF). Also, focusing information obtained by the camera processing unit 104 is transmitted to the Bayer resizing unit 130 through a path A. The Bayer resizing unit 130 interpolates or resizes the image data processed by the LPF by using the focusing information received from the camera processing unit 104, so as to perform resolution conversion to a hivision size such as a full high definition (FHD) size (1920×1080 pixels) or a high definition (HD) size (1280×720 pixels). Image data output from the Bayer resizing unit 130 is input to the Bayer interpolation unit 108. The Bayer interpolation unit 108 converts the Bayer data into YCbCr data and stores the YCbCr data in the SDRAM 124. The YCbCr data is MPEG-encoded by the MPEG encoder 112, is transmitted to the memory card interface 114, and is recorded in a memory card connected to the memory card interface 114.

If a captured image is a still image, image data processed by the camera processing unit 104 is transmitted in the form of Bayer data to the SDRAM 124 through the SDRAM interface 122 and is stored in the SDRAM 124. The Bayer data stored in the SDRAM 124 is converted into YCbCr data by the Bayer interpolation unit 108 and is stored in the SDRAM 124. The YCbCr data is JPEG-encoded by the JPEG encoder 110, is transmitted to the memory card interface 114, and is recorded in the memory card connected to the memory card interface 114. In addition to Bayer interpolation for converting Bayer data into YCbCr data, the Bayer interpolation unit 108 also performs a series of operations such as white balance adjustment, noise removal, and luminance and color correction.

The host CPU 120 controls operations of the other elements of the image pickup apparatus 100. Also, the LCD unit 118 is connected to the display interface 116 and displays a captured image stored in the SDRAM 124.

The Bayer resizing unit 130 includes an LPF. The LPF of the Bayer resizing unit 130 is mainly used to suppress interference waves of high frequencies, which are created when resolution conversion is performed. In this embodiment, the LPF of the Bayer resizing unit 130 has variable characteristics based on the focusing information obtained by the camera processing unit 104.

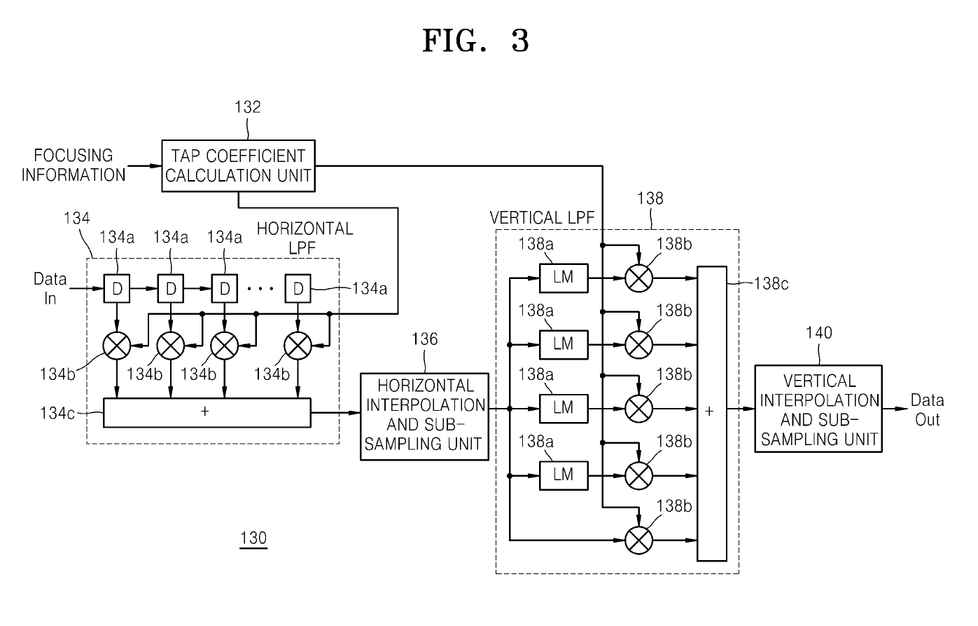

FIG. 3 is a block diagram of an example of the Bayer resizing unit 130 illustrated in FIG. 1, according to an embodiment of the present invention. The Bayer resizing unit 130 includes a tap coefficient calculation unit (filter control unit) 132, a horizontal LPF 134, a horizontal interpolation and sub-sampling unit 136, a vertical LPF 138, and a vertical interpolation and sub-sampling unit 140.

Focusing information obtained by the camera processing unit 104 and image data processed by the camera processing unit 104 in the form of Bayer data are input to the Bayer resizing unit 130. The focusing information is input to the tap coefficient calculation unit 132 and the image data is input to the horizontal LPF 134.

The tap coefficient calculation unit 132 calculates and outputs tap coefficients based on the focusing information. If a signal of the focusing information has a relatively large amplitude, an image region corresponding to the signal has high contrast and is an in-focus region, and thus the tap coefficient calculation unit 132 outputs tap coefficients for an LPF having increased high-frequency removal characteristics. On the other hand, if a signal of the focusing information has a relatively small amplitude, an image region corresponding to the signal has low contrast and is an out-of-focus region, and thus the tap coefficient calculation unit 132 outputs tap coefficients for an LPF having reduced high-frequency removal characteristics. As such, frequency band reduction performed by an LPF is varied based on the focusing information. Accordingly, if the LPF passes only a low frequency signal so as to reduce a resolution, a region having high resolution sense on an image may be increased and a large depth of field may be apparently achieved. Also, the out-of-focus region originally has a few high-frequency components and thus, although an LPF has reduced high-frequency removal characteristics, removal of interference waves by the LPF may not be greatly affected.

As illustrated in FIG. 3, the horizontal LPF 134 includes a plurality of flip-flops 134a, a plurality of multipliers 134b, and an adder 134c. The tap coefficients calculated by the tap coefficient calculation unit 132 are each transmitted to one of the multipliers 134b of the horizontal LPF 134 and are each multiplied by one of outputs of the flip-flops 134a. High-frequency components in a horizontal direction are removed from the image data by the horizontal LPF 134 and the image data is resized or interpolated by the horizontal interpolation and sub-sampling unit 136. An output of the horizontal interpolation and sub-sampling unit 136 is input to the vertical LPF 138. The vertical LPF 138 includes a plurality of line memories (LMs) 138a, a plurality of multipliers 138b, and an adder 138c. The tap coefficients calculated by the tap coefficient calculation unit 132 are each transmitted to one of the multipliers 138b of the vertical LPF 138, and are each multiplied by one of outputs of the LMs 138a. High-frequency components in a vertical direction are removed from the image data by the vertical LPF 138 and the image data is resized or interpolated by the vertical interpolation and sub-sampling unit 140. As such, resolution conversion is completely performed by the Bayer resizing unit 130 and an output of the vertical interpolation and sub-sampling unit 140 is transmitted to the Bayer interpolation unit 108 illustrated in FIG. 1.

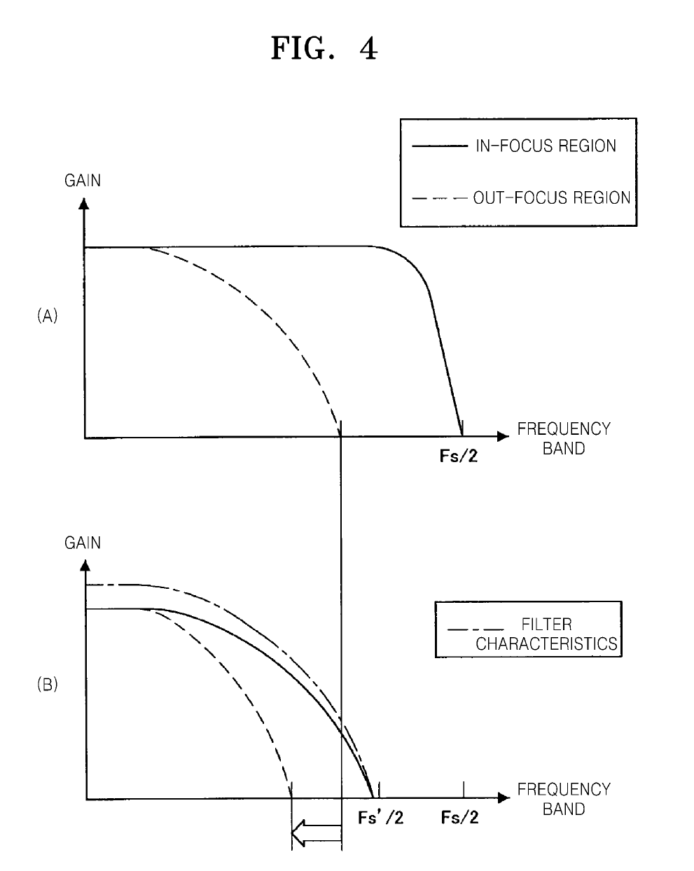

FIGS. 4A and 4B are graphs showing examples of frequency band removal characteristics of the horizontal and vertical LPFs 134 and 138 illustrated in FIG. 3, according to an embodiment of the present invention. Referring FIGS. 4A and 4B, a horizontal axis represents a frequency band of image data and a vertical axis represents gain of an LPF.

In FIG. 4A, a frequency band of image data included in Bayer data output from the camera processing unit 104 illustrated in FIG. 1 is shown, and regions indicated by solid and dashed lines represent in-focus and out-of-focus regions of the image data, respectively. In the in-focus region, the frequency band is distributed to a limit of resolution (Fs/2) of an image pickup device. However, in the out-of-focus region, a distribution range of the frequency band is reduced, a contrast is reduced, and thus a resolution sense is also reduced.

In FIG. 4B, a dashed dotted line represents filter coefficients (filter characteristics) to be multiplied by the solid and dashed lines of FIG. 4A. The solid and dashed lines of FIG. 4B represent the in-focus and out-of-focus regions on which resolution conversion is performed by performing a filtering operation using the filter characteristics of the dashed dotted line. Here, it is assumed that the resolution conversion is performed from a frequency Fs in FIG. 4A to a frequency Fs′ in FIG. 4B, due to the filtering operation.

The solid and dashed lines illustrated in FIG. 4B are obtained by multiplying the solid and dashed lines illustrated in FIG. 4A by the filter characteristics of the dashed dotted line. As illustrated in FIG. 4B, the resolution of the in-focus region is reduced according to the filter characteristics. Likewise, the resolution of the out-of-focus region is also reduced. Thus, an overall depth of field is not changed.

Accordingly, the Bayer resizing unit 130 illustrated in FIG. 1 processes the in-focus and out-of-focus regions by using different filter characteristics based on focusing information. The filtering operation is performed on the in-focus region (represented by the solid line of FIG. 4A) by using the filter characteristics of FIG. 4B.

However, the same filtering operation is not performed or the same resolution conversion is performed so as not to excessively reduce the frequency band, on the out-of-focus region (represented by the dashed line of FIG. 4A). As such, the contrast of an image of the out-of-focus region is also increased so as to be close to the contrast of an image of the in-focus region. Thus, a clear image of which an overall depth of field is large may be captured. Accordingly, an image having a large depth of field may be captured by adjusting filter coefficients according to a region based on focusing information.

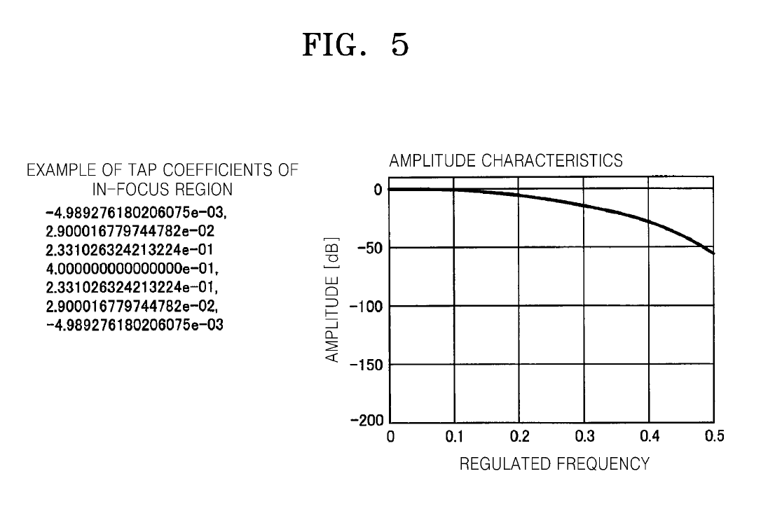

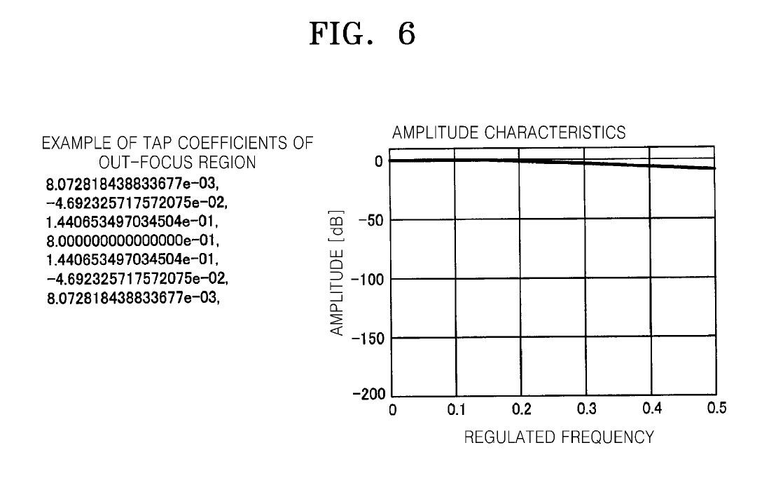

FIGS. 5 and 6 are graphs showing examples of amplitude characteristics of an LPF according to tap coefficients calculated by the tap coefficient calculation unit 132 illustrated in FIG. 3, according to an embodiment of the present invention. That is, FIG. 5 is a graph showing amplitude characteristics according to tap coefficients in an in-focus region. FIG. 6 is a graph showing amplitude characteristics according to tap coefficients in an out-of-focus region. Here, seven tap coefficients illustrated in FIG. 5 or FIG. 6 are separately input to the multipliers 134b and 138b of the horizontal and vertical LPFs 134 and 138 illustrated in FIG. 3. As illustrated in the amplitude characteristics of FIG. 5, high-frequency removal characteristics of the LPF may be increased in the in-focus region. On the other hand, as illustrated in the amplitude characteristics of FIG. 6, high-frequency removal characteristics of the LPF may be reduced in the out-of-focus region. Accordingly, a region having a high resolution sense on an image may be increased and a large depth of field may be achieved. Also, edge enhancement of the image may be achieved by performing edge enhancement filtering on the out-of-focus region.

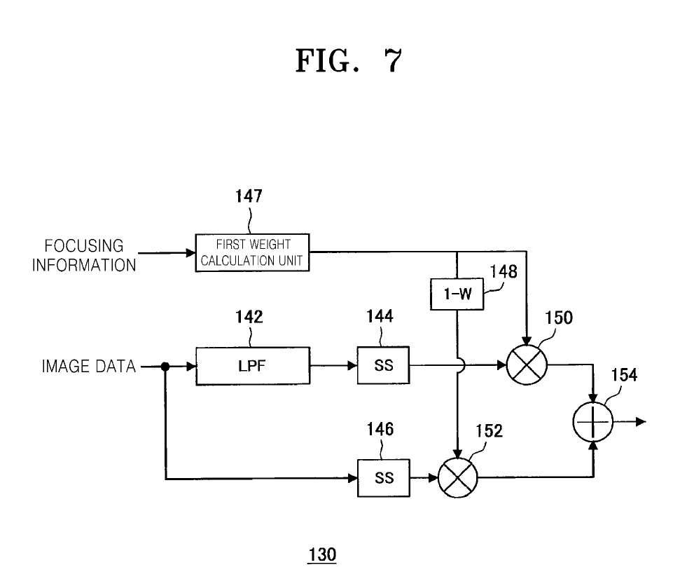

FIG. 7 is a block diagram of an example of the Bayer resizing unit 130 illustrated in FIG. 1, according to another embodiment of the present invention. Although the Bayer resizing unit 130 in FIG. 3 performs LPF filtering even on image data of an out-of-focus region, the Bayer resizing unit 130 in FIG. 7 performs only interpolation or resizing without performing LPF filtering, on the image data of the out-of-focus region. Thus, a clearer image and a larger depth of field may be achieved.

Referring to FIG. 7, the Bayer resizing unit 130 includes an LPF 142, first and second interpolation and sub-sampling units 144 and 146, first and second weight calculation units (filter control units) 147 and 148, first and second multipliers 150 and 152, and an adder 154. The LPF 142 performs a filtering operation in two directions such as horizontal and vertical directions. The LPF 142 performs resolution conversion on image data input to the Bayer resizing unit 130 by, for example, multiplying the image data by filter characteristics represented by the dashed dotted line illustrated in FIG. 4B. An output of the LPF 142 is input to the first interpolation and sub-sampling unit 144 so as to be interpolated or resized, and then is input to the first multiplier 150 as first image data. Also, the image data input to the Bayer resizing unit 130 is directly input to the second interpolation and sub-sampling unit 146 without being input to the LPF 142, so as to be interpolated or resized, and then is input to the second multiplier 152 as second image data.

Focusing information output from the camera processing unit 104 illustrated in FIG. 1 is input to the first weight calculation unit 147. The first weight calculation unit 147 calculates and outputs weight providing coefficients W (1>W>0) based on the focusing information. The weight providing coefficients W for the in-focus region are close to a value 1 and the weight providing coefficients W for the out-of-focus region are close to a value 0. The weight providing coefficients W are input to the first multiplier 150. Also, the weight providing coefficients W are also input to the second weight calculation unit 148. The second weight calculation unit 148 calculates coefficients 1−W and inputs the coefficients 1−W to the second multiplier 152.

The first multiplier 150 multiplies the first image data filtered by the LPF 142 and interpolated or resized by the first interpolation and sub-sampling unit 144, by the weight providing coefficients W input from the first weight calculation unit 147. Also, the second multiplier 152 multiplies the second image data not filtered by the LPF 142 and interpolated or resized by the second interpolation and sub-sampling unit 146, by the coefficients 1−W input from the second weight calculation unit 148. Then, outputs of the first and second multipliers 150 and 152 are input to the adder 154 so as to be added to each other.

In the Bayer resizing unit 130 according to the this embodiment, the weight providing coefficients W based on the focusing information are multiplied by the first image data filtered by the LPF 142, and the coefficients 1−W are multiplied by the second image data interpolated or resized without being filtered by the LPF 142. The ratio of the first image data to the second image data is controlled according to the weight providing coefficients W based on the focusing information. The first image data is greater than the second image data in an in-focus region where amplitudes of high-frequency components of image data are large. On the other hand, the second image data is greater than the first image data in an out-of-focus region where amplitudes of high-frequency components of image data are small. Since image data of the out-of-focus region is only interpolated or resized without being filtered by an LPF, a clearer image and a larger depth of field may be achieved in the out-of-focus region.

As can be appreciated from the above, the embodiments of the present invention provide an image pickup apparatus capable of preventing a small depth of field and capturing a clear image.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image pickup apparatus comprising:
a focusing information calculation unit which calculates focusing information of a captured image from an image signal read from an image pickup device;
a low pass filter which removes high-frequency components from the image signal; and
a filter control unit which controls the low pass filter to filter a region of the captured image,
wherein the filter control unit adjusts low pass filter characteristics differently based on the focusing information obtained from the image signal.

2. The image pickup apparatus of claim 1, wherein the filter control unit reduces high-frequency removal characteristics of the low pass filter in an out-of-focus region of the captured image compared to those in an in-focus region of the captured image, based on the focusing information.

3. The image pickup apparatus of claim 2, further comprising a processing unit which resizes or interpolates the image signal,
wherein the processing unit resizes or interpolates the image signal of an out-of-focus region of the captured image.

4. The image pickup apparatus of claim 1, wherein the filter control unit does not perform high-frequency removal using the low pass filter on the image signal of an out-of-focus region of the captured image, based on the focusing information.

5. The image pickup apparatus of claim 4, further comprising a processing unit which resizes or interpolates the image signal,
wherein the processing unit resizes or interpolates the image signal of an out-of-focus region of the captured image.

6. The image pickup apparatus of claim 1, wherein the low pass filter includes a horizontal low pass filter and a vertical low pass filter.

7. The image pickup apparatus of claim 6, further comprising:
a horizontal interpolation and sub-sampling unit which resizes or interpolates the image data as filtered by the horizontal low pass filter, and a vertical interpolation and sub-sampling unit which resizes or interpolates the image data as filtered by the vertical low pass filter.

8. An image pickup apparatus comprising:
a focusing information calculation unit which calculates focusing information of a captured image from an image signal read from an image pickup device;
a low pass filter which removes high-frequency components from the image signal;
a first processing unit which resizes or interpolates the image signal output from the low pass filter so as to output first image data;
a second processing unit which resizes or interpolates the image signal read from the image pickup device so as to output second image data;
a weight determination unit which determines weights of the first image data and the second image data based on the focusing information; and
an adder which linearly combines the first image data and the second image data according to the weights.

9. The image pickup apparatus of claim 8, wherein the weight determination unit increases the weight of the first image data and reduces the weight of the second image data in an in-focus region of the captured image, based on the focusing information.

10. The image pickup apparatus of claim 8, wherein the low pass filter does not perform high-frequency removal on the image signal of an out-of-focus region of the captured image based on the focusing information.

11. A method for operating an image pickup apparatus, the method comprising:
calculating focusing information of a captured image from an image signal read from an image pickup device;
filtering the image signal to remove high-frequency components from the image signal; and
controlling the filtering to filter a region of the captured image by adjusting low pass filter characteristics differently based on the focusing information obtained from the image signal.

12. The method of claim 11, wherein the controlling reduces high-frequency removal characteristics in an out-of-focus region of the captured image compared to those in an in-focus region of the captured image, based on the focusing information.

13. The method of claim 12, further comprising:
resizing or interpolating the image signal of an out-of-focus region of the captured image.

14. The method of claim 11, wherein the controlling refrains from performing high-frequency removal using the low pass filter on the image signal of an out-of-focus region of the captured image, based on the focusing information.

15. The method of claim 14, further comprising:
resizing or interpolating the image signal of an out-of-focus region of the captured image.

16. The method of claim 11, wherein the filtering includes performing a horizontal low pass filtering and a vertical low pass filtering.

17. The method of claim 16, further comprising:
resizing or interpolating the image data as filtered by the horizontal low pass filter and by the vertical low pass filter.

18. A method for operating an image pickup apparatus, the method comprising:
calculating focusing information of a captured image from an image signal read from an image pickup device;
performing low pass filtering to remove high-frequency components from the image signal;
resizing or interpolating the image signal that was low pass filtered so as to output first image data;
resizing or interpolating the image signal read from the image pickup device so as to output second image data;
determining weights of the first image data and the second image data based on the focusing information; and
linearly combining the first image data and the second image data according to the weights.

19. The method of claim 18, wherein the weight determining increases the weight of the first image data and reduces the weight of the second image data in an in-focus region of the captured image, based on the focusing information.

20. The method of claim 18, wherein the performing low pass filtering does not perform high-frequency removal on the image signal of an out-of-focus region of the captured image based on the focusing information.
